(19) United States
(12) Patent Application Publication
(10) Pub. No.: US 2005/0129478 A1
(43) Pub. Date: Jun. 16, 2005

(54) Storage apparatus

(76) Inventors: Orville L. Toles, Cincinnati, OH (US); Lynda Toles, Cincinnati, OH (US)

Correspondence Address: SIMON, GALASSO & FRANTZ PLC., P.O. Box 26503, Austin, TX, 78755-0503, US

(21) Appl. No.: 10/887,603

(22) Filed: Jul. 9, 2004

Related U.S. Application Data
(60) Provisional application No. 60/493,653, filed on Aug. 8, 2003.

(51) Int. Cl. B60P 7/12

(52) U.S. Cl. 410/34

(57) ABSTRACT

An apparatus configured for storing articles in a vehicle cargo bed comprises a housing, an article retaining member and a housing retention member. The housing has an article receiving recesses formed therein and a housing retention member mounting boss attached thereto. The article retaining member is configured for being mounted on the housing in a manner wherein the article retaining member extends across an open end of the article receiving recess. A housing retention member is configured for being attached to the housing retention member mounting boss of the housing. The housing retention member and the housing jointly define a recess configured for having a side rail portion of vehicle cargo bed captured therein.

### CROSS REFERENCE TO RELATED APPLICATIONS

This application claims priority to co-pending U.S. Provisional Patent Application having Ser. No. 60/493,653 filed Aug. 08, 2003, entitled “Tailgate Rail And Bow Carrier”, having a common applicant herewith.

### FIELD OF THE DISCLOSURE

The disclosures made herein relate generally to attachments for automobile accessory apparatuses for organizing and retaining cargo and, more particularly, to accessory apparatuses for organizing and retaining cargo in vehicle cargo beds.

### BACKGROUND

Soft tonneau covers are widely used on beds of pick-up trucks. The typical tonneau includes bows that span the bed, rails that extend generally parallel to the bows at opposite ends of the bed, and a cover that is mounted over the bows and rails. The components of tonneaus are often removably mounted on a bed for allowing the tonneau to be removed and installed as needed.

Examples of why tonneaus are a desirable accessory item include their securing articles in the bed, shielding the interior of the bed from the elements, improving aesthetic appeal and improving aerodynamic characteristics. However, one drawback of soft tonneaus is that, when not installed, the individual tonneau components (i.e., bows, rails and/or cover) are left unprotected and unorganised on the floor of the bed. This often leads to such components becoming damaged and/or soiled. Therefore, a storage apparatus configured for storage of elongated articles (e.g., soft tonneau components) that provides for storage in a manner that is convenient, simple and protective is useful.

### SUMMARY OF THE DISCLOSURE

In one embodiment, an apparatus configured for storing articles in a vehicle cargo bed comprises a housing having a plurality of article receiving stations configured for having elongated articles positioned therein, means for retaining the elongated articles within the article receiving stations and means for attaching the housing to a side rail portion of vehicle cargo bed.

In another embodiment, an apparatus configured for storing articles in a vehicle cargo bed comprises a housing, an article retaining member and a housing retention member. The housing has an article receiving recesses formed therein and a housing retention member mounting boss attached thereto. The article retaining member is configured for being mounted on the housing in a manner wherein the article retaining member extends across an open end of the article receiving recess. A housing retention member is configured for being attached to the housing retention member mounting boss of the housing. The housing retention member and the housing jointly define a recess configured for having a side rail portion of vehicle cargo bed captured therein.

In another embodiment, an apparatus configured for storing articles in a vehicle cargo bed comprises a housing, an article retaining member, a housing retention member and a compliant member. The housing has a plurality of elongated legs and a housing retention member mounting boss. Adjacent pairs of the legs each define a respective article receiving recess therbetweeen. The article retaining member includes opposing ends. At least one of the opposing ends is configured for being detachably attached to a respective one of the legs. The article retaining member is configured for extending across an open end of at least a portion of the recesses. The housing retention member is configured for being attached to the housing retention member mounting boss of the housing. The housing retention member and the housing jointly define a recess configured for having a side rail portion of vehicle cargo bed captured therein. The housing retention member and the housing retention member mounting boss are jointly configured for aligning the housing retention member in a retention position with respect to the housing. The compliant member is attached to the article retaining member in a manner wherein the complaint member is exposed at an open end of each article receiving recess when the article retaining member is mounted on the housing.

Correspondingly, it is a principal object of the inventive disclosures made herein to provide a storage apparatus configured for storing articles in a vehicle cargo bed that overcomes drawbacks associated with conventional approaches for storing soft tonneaus in a vehicle cargo bed. Specifically, storage apparatuses in accordance with embodiments of the inventive disclosures made herein provide for secure, protected and organized storage of elongated articles such as tonneau bows and rails when such components are not installed. Accordingly, such components are far less likely to become damaged and/or soiled.

Turning now to specific embodiments of the inventive disclosures made herein, in at least one embodiment of the inventive disclosures made herein, each one of the stations include a respective recess in the housing.

In at least one embodiment of the inventive disclosures made herein, the means for retaining includes an article retaining member configured for being attached to the housing.

In at least one embodiment of the inventive disclosures made herein, the article retaining member is configured for being mounted on the housing in a manner wherein the article retaining member extends across an open end of the recess of each one of said stations.

In at least one embodiment of the inventive disclosures made herein, the housing includes a plurality of legs, the recess of each one of the stations is defined between an adjacent pair of the legs; and the article retaining member is detachably attached to at least one of the legs.

In at least one embodiment of the inventive disclosures made herein, the means for attaching includes a housing retention member and the housing is configured for having the housing retention member attached thereto.

In at least one embodiment of the inventive disclosures made herein, the housing retention member and the housing jointly define a recess for having the side rail portion of said vehicle cargo bed captured therein.

In at least one embodiment of the inventive disclosures made herein, the means for retaining includes an article retaining member configured for being attached to the housing, each one of said stations include a respective recess in the housing and the article retaining member is configured for being mounted on the housing in a manner wherein the article retaining member extends across an open end of the recess of each one of the stations.

In at least one embodiment of the inventive disclosures made herein, the housing retention member and the housing are jointly configured for aligning the housing retention member in a retention position with respect to the housing.

In at least one embodiment of the inventive disclosures made herein, a compliant member is provided on at least one of the article retaining member and the housing within at least one of recess.

In at least one embodiment of the inventive disclosures made herein, the article support surface of at least one of the legs of a housing has a curved profile.

These and other objects and embodiments of the inventive disclosures made herein will become readily apparent upon further review of the following specification and associated drawings.

### BRIEF DESCRIPTION OF THE DRAWINGS

FIG. 1 depicts a storage system in accordance with a first embodiment of the inventive disclosures made herein;

FIG. 2 is an exploded view of a storage apparatus of the storage system depicted in FIG. 1;

FIG. 3 is a cross sectional view taken along the line 3-3 in FIG. 1;

FIG. 4 depicts a storage apparatus having arc-shaped article engagement surfaces; and

FIG. 5 depicts a storage system comprising two of the storage apparatuses depicted in FIG. 4.

### DETAILED DESCRIPTION OF THE DRAWINGS

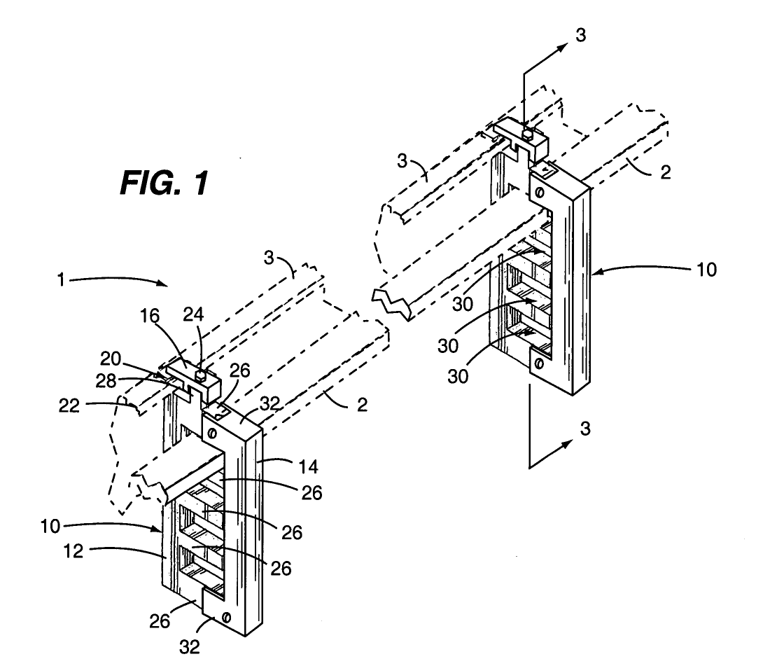

FIG. 1 depicts a storage system 1 configured for storing articles 2 (e.g., elongated articles of a soft tonneau) in a vehicle cargo bed 3 in accordance with an embodiment of the inventive disclosures made herein. The storage system 1 includes a pair of spaced apart storage apparatuses 10. Preferably, each one of the storage apparatuses 10 is secured to the vehicle cargo bed 3.

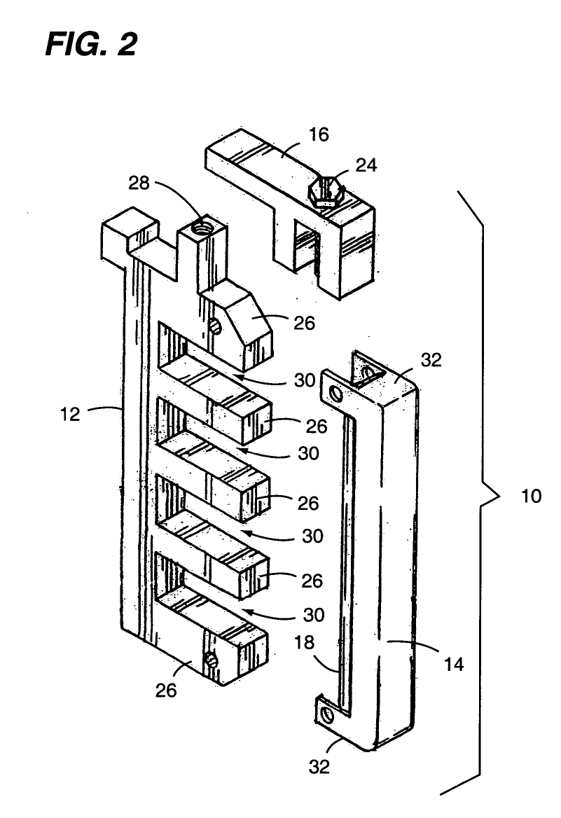

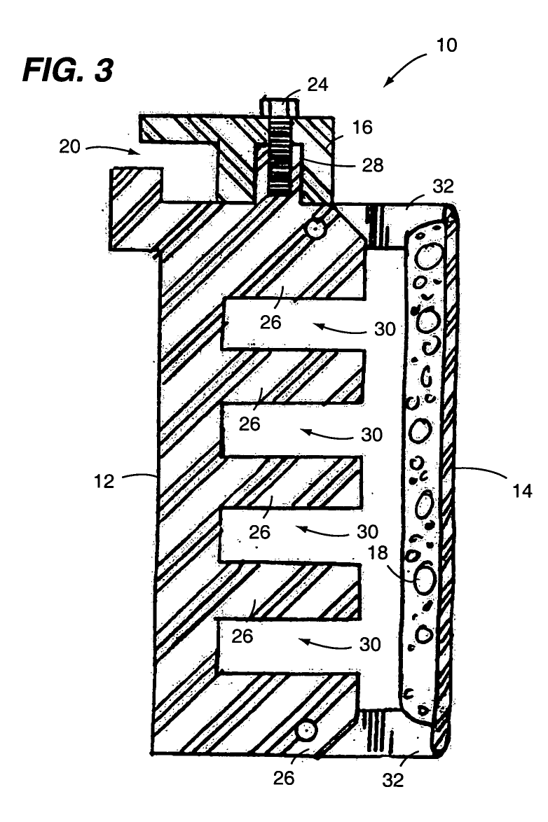

Referring now to FIGS. 1-3, each apparatus 10 includes a housing 12, an article retaining member 14, a housing retention member 16 and a compliant member 18. The housing retention member 16 and the housing 12 jointly define a recess 20 (FIGS. 1 and 2) configured for having a side rail portion 22 (FIG. 1) of vehicle cargo bed 3 captured therein. A fastener 24 (e.g., a bolt) is provided for securing the housing retention member 16 to the housing 12. Broadly, a side rail and a tailgate of a vehicle cargo bed are disclosed herein to be examples of the perimeter rail portion 22

The housing 12 has a plurality of elongated legs 26 and a housing retention member mounting boss 28. Adjacent pairs of the legs 26 each define a respective article receiving recess 30 therbetweeen. The recesses 30 define respective article receiving stations that are configured for having elongated articles positioned therein.

The article retaining member 14 includes opposing ends 32. The opposing ends 32 are configured for being detachably attached to a respective one of the legs 26. In one embodiment, the opposing ends 32 are secured to the respective one of the legs 26 by commercially available fasteners (e.g., bolts, hitch pins, etc). The article retaining member 14 is configured for extending across an open end of at least a portion of the recesses 20. In this manner, the apparatus 10 is provides for elongated articles (e.g., soft tonneau bows and rails) to be retained in a secure and safe manner. The article retaining member 14 is an embodiment of a means for retaining elongated articles within article receiving stations of the housing 12.

The housing retention member 16 and the housing retention member mounting boss 28 are jointly configured for aligning the housing retention member 16 in a retention position with respect to the housing. Accordingly, the housing retention member 16 is configured for being attached to the housing retention member mounting boss 28 of the housing 12. The retention position is defined herein to be a position in which the recess 20 configured for having the side rail portion 22 (FIG. 1) of vehicle cargo bed 3 captured therein is provided. The housing retention member 16 and the housing retention member mounting boss 28 jointly depict an embodiment of a means for attaching the housing to a side rail portion of vehicle cargo bed.

The compliant member 18 is attached to the article retaining member 14. Broadly, a compliant member in accordance with the inventive disclosures made herein is a member of a structure that is configured for offering compliant contact with engaged articles. A foam pads, a spring-loaded member and the like are examples of the compliant member 18. In one embodiment, the complaint member 18 is exposed at an open end of each article receiving recess 20 when the article retaining member 14 is mounted on the housing 12. In other embodiments (not shown), the compliant member is mounted on the housing within at least a portion of the recesses 20.

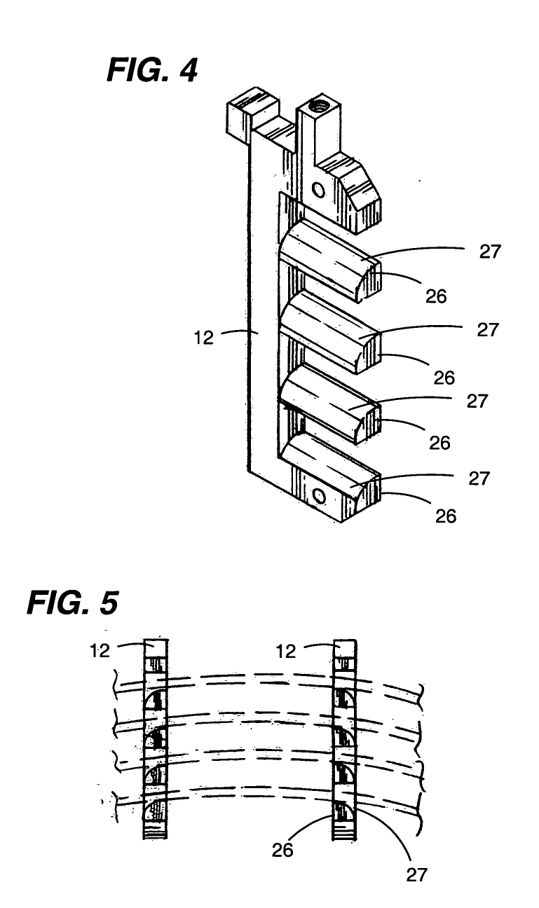

FIGS. 4 and 5 depict a second embodiment of the housing 12 wherein an article support surface 27 of each leg 26 of the housing 12 has a profile that is curved (i.e., curved in the cross sectional view). In this manner, the article support surface 27 follows the general curvature of elongated articles that have an as-stored arched shape. In this manner, the load of the articles is better distributed on the legs 26 during storage.

Storage apparatuses in accordance with embodiments of the inventive disclosures made herein are relatively inexpensive, easy to use and convenient to install and store. Such apparatuses are preferably configured for being secured onto the side or tailgate of a pick-up truck cargo bed. A preferred utility for storage apparatuses in accordance with embodiments of the inventive disclosures made herein is storage of components (e.g., rails, bows and/or covering) of a soft tonneau used to cover a cargo bed of a pick-up truck. Such apparatuses provide a readily available and safe means for storing such soft tonneau components. Advantageously, storage apparatuses in accordance with embodiments of the inventive disclosures made herein may be attached to a vehicle cargo bed in a temporary, yet firmly fastened manner. Furthermore, having such tonneau components stored directly in the vehicle cargo bed advantageously allows the tonneau to be conveniently removed and replaced, as desired and/or necessary.

Preferably, the major elements (i.e., housing, article retaining member, housing retention member and compliant member) of storage apparatuses in accordance with embodiments of the inventive disclosures made herein are formed from plastic materials using known fabrication techniques. Examples of such fabrication techniques include molding, extrusion, vacuum forming, cutting, drilling, turning, milling, thermal forming, and/or ultrasonic welding. Optionally, all or a portion of the major components of such storage apparatuses are made from other types of materials such as aluminium, laminated composite, steel etc. Certain minor elements (e.g., fasteners) are preferably off-the-shelf articles (e.g., available from a catalog of articles

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice embodiments of the inventive disclosures made herein. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

1. An apparatus configured for storing articles in a vehicle cargo bed, comprising:
a housing having a plurality of article receiving stations configured for having elongated articles positioned therein; and
means for retaining said elongated articles within said stations; and
means for attaching the housing to a side rail portion of vehicle cargo bed.

2. The apparatus of claim 1 wherein an article support surface of at least one of said legs has a non-linear cross-sectional profile.

3. The apparatus of claim 1 wherein each one of said stations include a respective recess in the housing.

4. The apparatus of claim 3 wherein:
said means for retaining includes an article retaining member configured for being attached to the housing; and
the article retaining member is configured for being mounted on the housing in a manner wherein the article retaining member extends across an open end of the respective recess of each one of said stations.

5. The apparatus of claim 3 wherein:
the housing includes a plurality of legs;
the respective recess of each one of said stations is defined between an adjacent pair of said legs; and
the article retaining member is detachably attached to at least one of said legs.

6. The apparatus of claim 1 wherein:
said means for attaching includes a housing retention member;
the housing is configured for having the housing retention member attached thereto; and
the housing retention member and the housing jointly define a recess for having the side rail portion of said vehicle cargo bed captured therein.

7. The apparatus of claim 6 wherein:
said means for retaining includes an article retaining member configured for being attached to the housing;
each one of said stations include a respective recess in the housing;
the article retaining member is configured for being mounted on the housing in a manner wherein the article retaining member extends across an open end of the respective recess of each one of said stations.

8. The apparatus of claim 7, wherein the housing retention member and the housing are jointly configured for aligning the housing retention member in a retention position with respect to the housing.

9. The apparatus of claim 8, further comprising:
a compliant member provided on at least one of the article retaining member and the housing within a respective recess of at least one of said stations.

10. The apparatus of claim 1 wherein:
said means for retaining includes an article retaining member configured for being attached to the housing;
each one of said stations include a respective recess in the housing;
the housing includes a plurality of legs;
an article support surface of at least one of said legs has a non-linear cross-sectional profile;
the respective recess of each one of said stations is defined between an adjacent pair of said legs;
the article retaining member is detachably attached to at least one of said legs; and
the article retaining member includes a compliant member mounted thereon in a manner wherein the complaint member is exposed at an open end of the respective recess of each one of said stations when the article retaining member is mounted on the housing.

11. The apparatus of claim 10 wherein:
said means for attaching includes a housing retention member;
the housing is configured for having the housing retention member attached thereto;
the housing retention member and the housing jointly define a recess for having the side rail portion of said vehicle cargo bed captured therein; and
the housing retention member and the housing are jointly configured for aligning the housing retention member in a retention position with respect to the housing.

12. An apparatus configured for storing articles in a vehicle cargo bed, comprising:
a housing having an article receiving recess formed therein and a housing retention member mounting boss attached thereto;
an article retaining member configured for being mounted on the housing in a manner wherein the article retaining member extends across an open end of the article receiving recess; and
a housing retention member configured for being attached to the housing retention member mounting boss of the housing, wherein the housing retention member and the housing jointly define a recess configured for having a side rail portion of vehicle cargo bed captured therein.

13. The apparatus of claim 12 wherein an article support surface defining the article receiving recess has a non-linear profile.

14. The apparatus of claim 12 wherein the housing retention member and the housing retention member mounting boss are jointly configured for aligning the housing retention member in a retention position with respect to the housing.

15. The apparatus of claim 12 wherein a compliant member is provided on at least one of the housing within the article receiving recess and the article retaining member at a position for being exposed at an open end of the article receiving recess when the article retaining member is mounted on the housing.

16. The apparatus of claim 12 wherein:
the housing includes a pair of legs;
the article receiving recess is defined between said legs; and
the article retaining member is removable attached to at least one of said legs.

17. The apparatus of claim 16 wherein the housing retention member and the housing retention member mounting boss are jointly configured for aligning the housing retention member in a retention position with respect to the housing.

18. The apparatus of claim 12 wherein:
the housing retention member and the housing retention member mounting boss are jointly configured for aligning the housing retention member in a retention position with respect to the housing;
the housing includes a pair of legs;
the article receiving recess is defined between said legs;
an article support surface of at least one of said legs has a non-linear cross-sectional profile;
the article retaining member is removable attached to at least one of said legs; and
the article retaining member includes a compliant member mounted in a manner wherein the complaint member is exposed at an open end of the article receiving recess when the article retaining member is mounted on the housing.

19. An apparatus configured for storing articles in a vehicle cargo bed, comprising:
a housing having a plurality of elongated legs and a housing retention member mounting boss, wherein adjacent pairs of said legs each define a respective article receiving recess therebetween and wherein an article support surface of at least one of said legs has a non-linear cross-sectional profile;
an article retaining member including opposing ends, wherein at least one of said ends is configured for being detachably attached to a respective one of said legs and wherein the article retaining member is configured for extending across an open end of at least a portion of said recesses;
a housing retention member configured for being attached to the housing retention member mounting boss of the housing, wherein the housing retention member and the housing jointly define a recess configured for having a side rail portion of vehicle cargo bed captured therein and wherein the housing retention member and the housing retention member mounting boss are jointly configured for aligning the housing retention member in a retention position with respect to the housing; and
a compliant member attached to the article retaining member in a manner wherein the complaint member is exposed at an open end of each article receiving recess when the article retaining member is mounted on the housing.
